(19) United States
(12) Patent Application Publication
(10) Pub. No.: US 2009/0150784 A1
(43) Pub. Date: Jun. 11, 2009

(54) USER INTERFACE FOR PREVIEWING VIDEO ITEMS

(75) Inventors: JUSTIN S. DENNEY, SEATTLE, WA (US); TIMOTHY C. HOAD, KIRKLAND, WA (US); HUGH E. WILLIAMS, REDMOND, WA (US); RICHARD J. QIAN, SAMMAMISH, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/952,908

(22) Filed: Dec. 7, 2007

(51) Int. Cl. G06F 3/01

(52) U.S. Cl. 715/722; 715/719

(57) ABSTRACT

Systems, methods, and user interfaces for presenting video search results are provided. Representations of video search results are presented to the user. Each representation may include a video preview of the video item. If desired, the preview may be dynamically executed in response to a user action, for instance, in response to a user hovering over a portion of the associated video representation for at least a predetermined period of time. Another embodiment in accordance with the present invention relates to a user interface for presenting video search results in response to an input query. The user interface includes a video item representation display area and a video item display area. The video item representation display area displays a representation of each of the video items, and if desired, the representation is dynamically executed in response to a user action. The video item display area may display the one or more video items.

### CROSS-REFERENCE TO RELATED APPLICATIONS

This application is related by subject matter to the invention disclosed in the commonly assigned application U.S. patent application Ser. No. 11/722,101, entitled “Forming a Representation of a Video Item and Use Thereof”, filed on Jun. 29, 2007.

### SUMMARY

Embodiments of the present invention relate to systems, methods, and user interfaces for presenting video search results. Representations of video search results are presented to the user. Each representation may include a video preview of the video item. If desired, the preview may be dynamically executed in response to a user action, for instance, in response to a user hovering over a portion of the associated video representation for at least a predetermined period of time.

This Summary is provided to introduce a selection of concepts in a simplified form that are further described below in the Detailed Description. This Summary is not intended to identify key features or essential features of the claimed subject matter nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary computing system suitable for presenting video search results, in accordance with an embodiment of the present invention;

FIG. 3 is a flow diagram showing a method for presenting video search results, in accordance with an embodiment of the present invention;

FIG. 4 is an illustrative screen display, in accordance with an embodiment of the present invention, of an exemplary user interface showing video search results;

FIG. 5 is an illustrative screen display, in accordance with an embodiment of the present invention, of an exemplary user interface showing video search results and a selected video content item; and

FIG. 6 is a block diagram illustrating a video preview generating component in accordance with an embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and user interfaces for presenting video search results. More specifically, video search results may be determined and representations of the video search results are presented to the user, where a representation includes a video preview of the video item. If desired, the preview may be dynamically executed in response to a user action, for instance, in response to a user hovering over a portion of the associated video representation for at least a predetermined period of time.

Having briefly described an overview of embodiments of the present invention, an exemplary operating environment suitable for use in implementing embodiments of the present invention is described below.

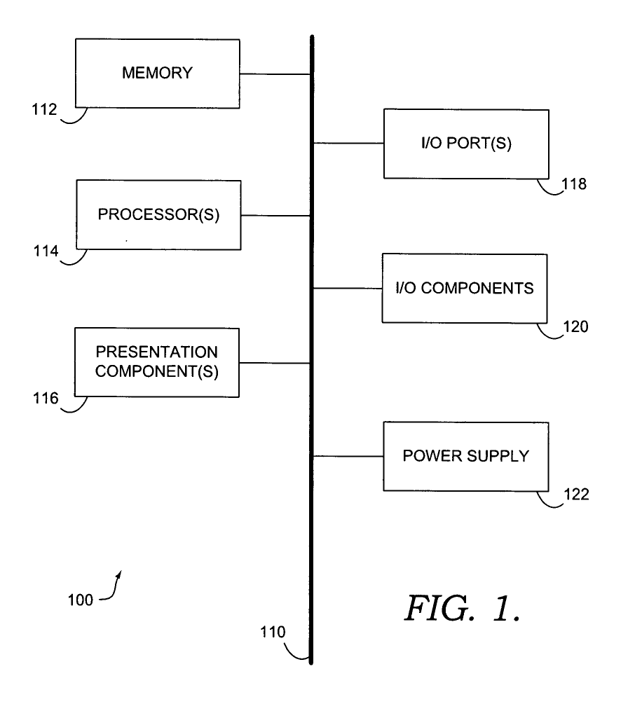

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CD-ROM, digital versatile discs (DVD) or other optical or holographic media; magnetic cassettes, magnetic tape, magnetic disk storage or other magnetic storage devices; or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

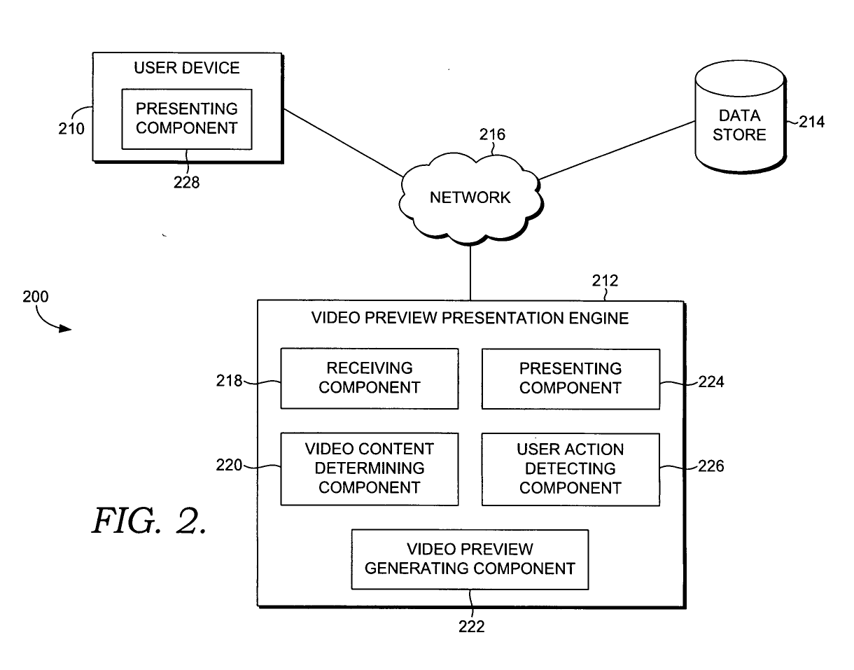

Turning now to FIG. 2, a block diagram is illustrated that shows an exemplary computing system 200 configured to present video search results, in accordance with an embodiment of the present invention. It will be understood and appreciated by those of ordinary skill in the art that the computing system 200 shown in FIG. 2 is merely an example of one suitable computing environment and is not intended to suggest any limitation as to the scope of use or functionality of the present invention. Neither should the computing system 200 be interpreted as having any dependency or requirement related to any single component/module or combination of components/modules illustrated herein.

Computing system 200 includes a user device 210, a video preview presentation engine 212, and a data store 214, all in communication with one another via a network 216. The network 216 may include, without limitation, one or more local area networks (LANs) and/or wide area networks (WANs). Such networking environments are commonplace in offices, enterprise-wide computer networks, intranets, and the Internet. Accordingly, the network 216 is not further described herein.

The data store 214 may be configured to store information associated with various data content items, as more fully described below. It will be understood and appreciated by those of ordinary skill in the art that the information stored in the data store 214 may be configurable and may include information relevant to data content items that may be extracted for indexing. Further, though illustrated as a single, independent component, data store 214 may, in fact, be a plurality of data stores, for instance, a database cluster, portions of which may reside on a computing device associated with the video preview presentation engine 212, the user device 210, another external computing device (not shown), and/or any combination thereof.

Each of the video preview presentation engine 212 and the user device 210 shown in FIG. 2 may be any type of computing device, such as, for example, computing device 100 described above with reference to FIG. 1. By way of example only and not limitation, the video preview presentation engine 212 and/or the user device 210 may be a personal computer, desktop computer, laptop computer, handheld device, mobile handset, consumer electronic device, and the like. It should be noted, however, that the present invention is not limited to implementation on such computing devices, but may be implemented on any of a variety of different types of computing devices within the scope of the embodiments hereof

As shown in FIG. 2, the video preview presentation engine 212 includes a receiving component 218, a video content determining component 220, a video preview generating component 222, a presenting component 224, and a user action detecting component 226. In some embodiments, one or more of the illustrated components 218, 220, 222, 224, and 226 may be integrated directly into the operating system of the video preview presentation engine 212 or the user device 210. In the instance of multiple servers, embodiments of the present invention contemplate providing a load balancer to federate incoming queries to the servers. It will be understood by those of ordinary skill in the art that the components 218, 220, 222, 224, and 226 illustrated in FIG. 2 are exemplary in nature and in number and should not be construed as limiting. Any number of components may be employed to achieve the desired functionality within the scope of the embodiments of the present invention.

The receiving component 218 is configured for receiving requests for information, for instance, a user request for presentation of a particular video, a user-input search query, etc. Upon receiving a request for information, the receiving component is configured to transmit such request, for instance, to data store 214, whereupon a video content item responding to the input request is returned to the receiving component 218. In this regard, the receiving component 218 is configured for receiving video content items. By way of example only, in one embodiment, at least a portion of the video content items are search query result items. In this instance, the receiving component 218 may transmit the request for information (that is, the search query) to data store 214, whereupon a plurality of search results, each representing a video content item, is returned to the receiving component 218.

In embodiments, rather than transmitting requests for information directly from the receiving component 218 to the data store 214, a received request for information may be transmitted through the video content determining component 220. In this regard, the video content determining component 220 is configured for receiving requests for information from the receiving component 218 and for transmitting such requests, for instance, to data store 214. Subsequently, a video content item responding to the search request is returned to the video content determining component 220 which, in turn, transmits the video content item responding to the search result to the receiving component 218. It will be understood by those of ordinary skill in the art that the illustrated receiving component 218 and video content determining component 220 work closely with one another to receive input user requests for information and to query one or more data stores (for instance, data store 214) for information in response to received requests for information. The functionality of these components is, accordingly, closely intertwined and certain features thereof may be performed by either component exclusively or a combination of the two components 218, 220. Additionally, the functionality may be combined into a single component, if desired. Any and all such variations are contemplated to be within the scope of embodiments of the present invention.

The video preview generating component 222 is configured for generating a video preview of the video content items. One skilled in the art will appreciate that any suitable method may be used to create such a preview, which is more fully described below. As used herein, a video preview is a video summarizing a video content item comprising one or more segments from the video content item, where the video preview provides the user with enough information about the video content item to allow the user to know if watching the entire video content item is desired. A video preview of a video content item may, for example, provide highlights of the video (e.g., by presenting part of each scene of the video). One skilled in the art will appreciate that the length of a video preview may vary as necessary. In one embodiment, a video preview will be less than half of the total length of the associated video content item and/or will be less than thirty seconds in length. The representation may statically represent the first scene of the total video item or the first segment of the video preview of the video item. Furthermore, in one embodiment, when executed by the appropriate user action, the video preview of only one video item representation will play at a time.

One skilled in the art will understand that the generation of a video preview may vary depending on the search query provided by the user and/or the desired video content item. For example, if the video content item is a music video, the video preview may comprise fewer segments of a longer length in the preview, which allows the user to better hear and understand the music or song (e.g, three ten-second segments within the preview). Or, if the video content item is a movie trailer, for example, the video preview may be a continuous segment for the entire thirty second duration.

The presenting component 224 is configured for presenting a plurality of video content items and, in some embodiments, the web page in association with which the video content items are to be presented in response to the user input request for information (e.g., from receiving component 218), and further configured for transmitting such video content items to a corresponding presenting component 228 associated with user device 210. The presenting component 228 associated with the user device 210 is accordingly configured to receive the video content items and associated video representations and previews from presenting component 224 of the video representation engine 212 and for presenting (e.g., displaying) such video content items and representations and previews to the user. The presenting component 228 of the user device 210 may present the representations and/or previews utilizing a variety of different user interface components, several of which are described more fully below.

Video previews may be presented in association with the corresponding video item upon presentation of the web page presented in response to the user request for information, may be presented only upon detection of particular user actions, or any combination thereof. In embodiments wherein presentation is conditioned upon detection of a particular user action, the user action determining component 226 is configured for determining if one or more user-driven conditions (e.g., user actions) have been met prior to the presenting component 224 presenting the determined video content preview. In this regard, the user action determining component 226 is configured to detect and/or receive input of user actions and to determine if the detected/received user actions satisfy one or more actions upon which presentation is conditioned. Exemplary user actions may include, without limitation, a hover over at least a portion of a video content item or representation of a video content item, a scrolling action with respect to a particular presented video content item, or a selection of a selectable portion of a video content item. Upon detection of a user action upon which execution of a video preview is conditioned, the user action determining component 226 is further configured to provide an indication to the presenting component 224 that presentation is to be initiated. Accordingly, each video preview can be dynamically executed or presented in response to the detected user action.

Additionally, the presenting component 224 may present control buttons in response to a user action. Such control buttons may appear with the execution of the video preview, and would allow the user the ability to control the video preview. Exemplary control buttons may allow the user to mute the video preview, save the video preview, etc.

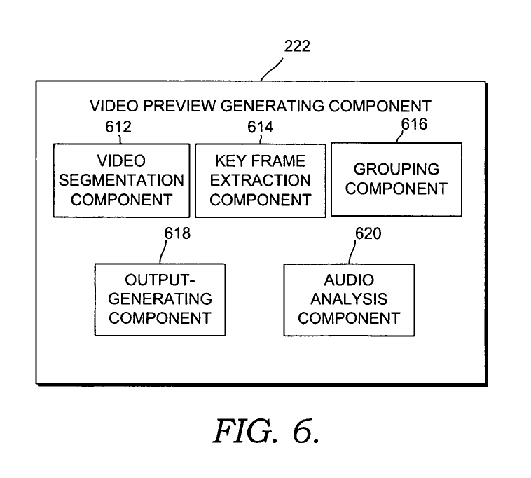

FIG. 6 further illustrates video preview generating component 222 of FIG. 2. In FIG. 6, the video preview generating component 222 includes a video segmentation component 612, a key frame extraction component 614, a grouping component 616, an output-generating component, and an audio analysis component 620. As discussed above, the video content item comprises video content of any length. The video content can include visual information and, optionally, audio information. The video information can be expressed in any format, for example, WMV, MPEG2/4, etc. The video content item is composed of a plurality of frames. Essentially, each frame provides a still image in a sequence of such images that comprise a motion sequence.

The video content item may include a plurality of segments. Each segment may correspond to a motion sequence. In one case, each segment is demarcated by a start-recording event and a stop-recording event. The video content item may also correspond to a plurality of scenes. The scenes may semantically correspond to different events captured by the video item, and a single scene may include one or more segments.

In FIG. 6, the video segmentation component 612 segments the video content item into multiple segments, where each segment may be associated with a start-recording event and a stop-recording event. One skilled in the art will understand that various methods may be used to segment the video content item, such as by determining visual features associated with each frame of the video content item. These visual features may then be used to determine the boundaries between segments.

Subsequently, at least one key frame from each segment is extracted by the key frame extraction component 614, where the key frame serves as a representation of each video segment. A key frame may be determined using various methods. For example, the frame stability feature or frame visual quality feature for each frame may be determined. The key frame extraction component 614 may also determine a user attention feature for each frame which measures whether a frame likely captures the intended subject matter of the video segment.

After the key frames have been extracted, the grouping component 616 groups the video segments into semantic scenes. To group the segments, the grouping component 616 may identify whether two video segments are visually similar, indicating that these segments may correspond to the same semantic scene. Once the segments are grouped, the output-generating component 618 may select final key frames, and may further select segments corresponding to the key frames. The output-generating component 618 may add transitions to these segments to generate the video preview of the video content item.

Optionally, the audio features of the video content item may be taken into account when generating a video preview using audio analysis component 620. For example, key frames and associated video segments that have interesting audio information, such as speech information, music information, etc., may be used to determine the segments selected to comprise the video preview.

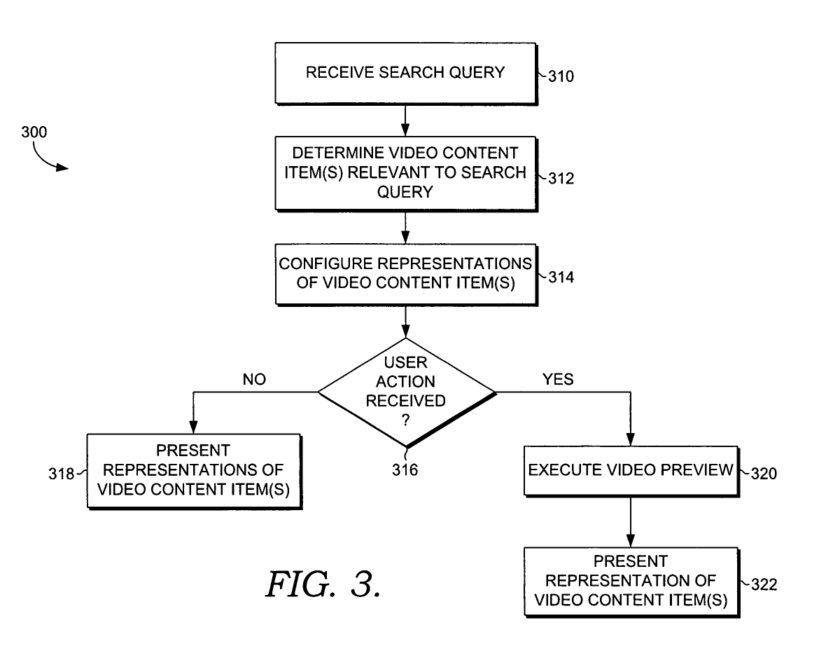

Turning now to FIG. 3, a flow diagram is illustrated which shows a method 300 for presenting video content items, in accordance with an embodiment of the present invention. Initially, as indicated at block 310, a request for user information is received, e.g., by utilizing receiving component 218 of FIG. 2. Subsequently, one or more video content items relevant to the user's information request are received, as indicated at block 312. As previously described, such content items may be received, by way of example only, upon the receiving component 218 of FIG. 2 directly querying the data store 214, may be received from video content item determining component 220, or any combination thereof.

Next, as indicated at block 314, representations of video content items are configured. It will be understood that blocks 312 and 314 are optional in that, for some embodiments of the present invention, the video content items may already have been configured as representations and indexed (e.g., in data store 214 in FIG. 2). In embodiments, the video preview associated with the video content item may also be configured prior to receiving a request from a user. The indexed representation and video preview may then be accessed, for instance, from data store 214. The representations may, for example, be in the form of thumbnails and may statically show the first scene from the video content item, the first scene from a video preview of the video content item, or the like. Then, as indicated at block 316, it is determined whether any user actions upon which presentation of video previews is conditioned have been detected, for instance, utilizing user action determining component 226 of FIG. 2. If no user actions upon which presentation of the video previews is conditioned have been detected, each representation of the video content items will be presented without playing a video preview, for instance, utilizing presenting components 224 and 228 of FIG. 2. This is indicated at block 318. As previously described, exemplary user actions may include, without limitation, a hover over at least a portion of a video content item or video representation associated therewith, a scrolling action with respect to the web page in association with which video content items are presented, a scrolling action with respect to a particular presented video content item, a selection of a selectable portion of a video content item, a hover over a video preview indicator associated with one or more presented video representations (more fully described below), an election of a video preview indicator associated with one or more presented video representations, or any combination thereof. If, however, one or more user actions upon which presentation of video previews is conditioned have been detected, a video preview is created and executed (for instance, utilizing video preview generating component 222 of FIG. 2), as indicated at block 320. The representations of the video content items are presented at block 322. It will be understood that, although block 320 is above block 322, the representations are presented simultaneous to the execution of the video preview. In other words, assuming more than one video content item is relevant to the search query, one preview may be executed upon the detection of a user action, while the representations associated with the other video content items are presented.

It will be understood by those of ordinary skill in the art that the order of steps shown in the method 300 of FIG. 3 are not meant to limit the scope of the present invention in any way and, in fact, the steps may occur in a variety of different sequences within embodiments hereof. For instance, the video previews may be created (shown at step 320 of FIG. 3) prior to determining if any user-driven conditions have been met (shown at step 316 of FIG. 3). In such an embodiment, the video previews may be cached or otherwise hidden from presentation until such time as the user actions upon which presentation is conditioned are detected and/or determined. Any and all such variations, and any combinations thereof, are contemplated to be within the scope of embodiments of the present invention.

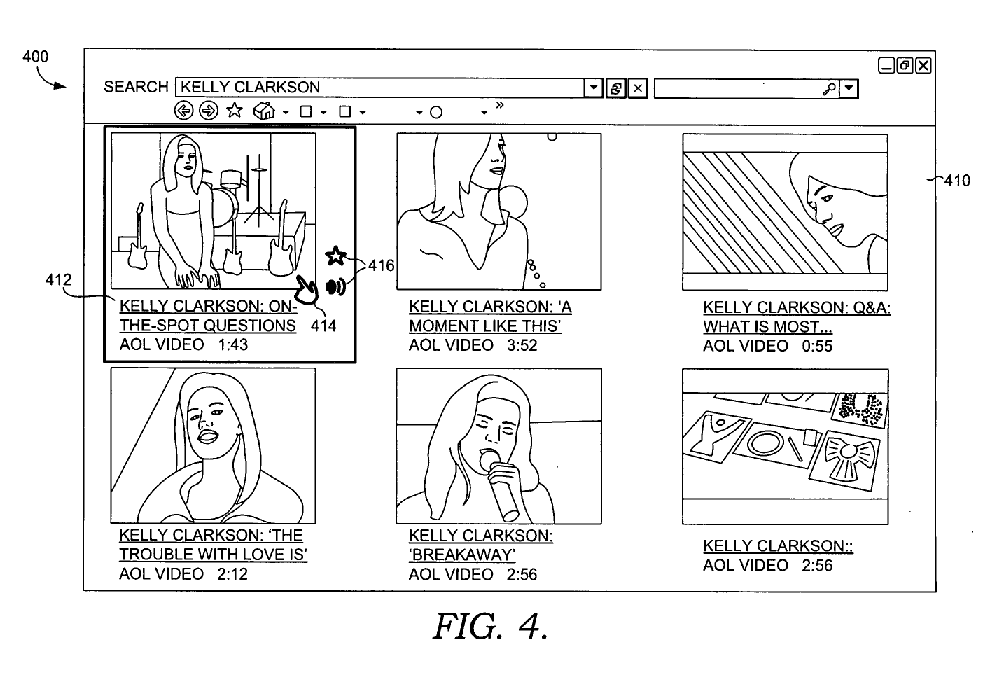

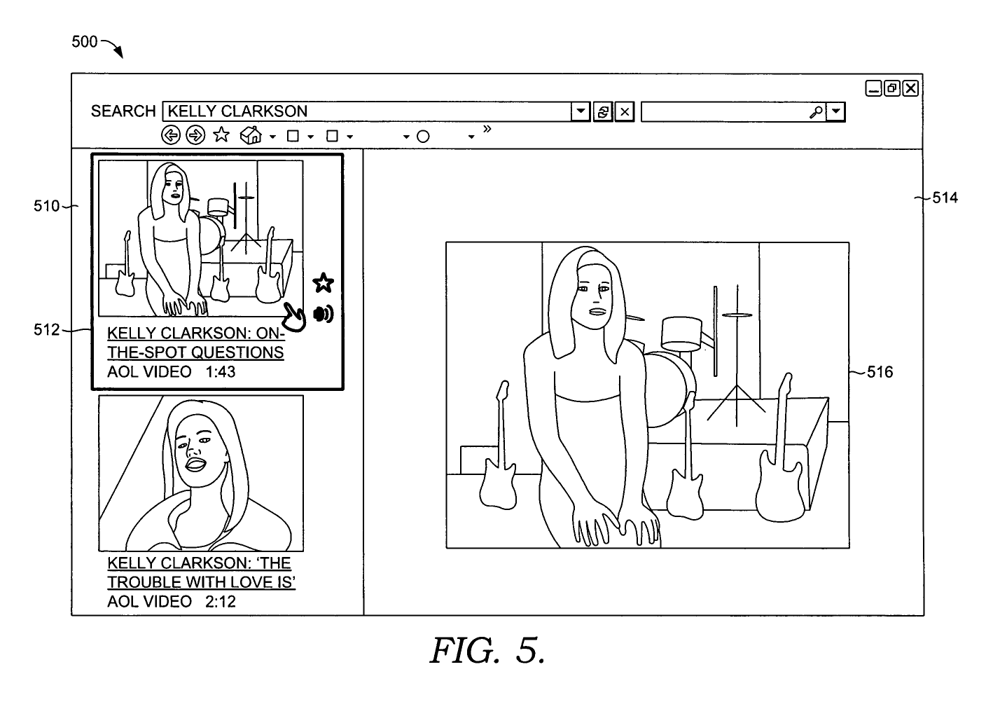

As previously mentioned, video representations and video previews may be presented utilizing a variety of user interface features. Such features may include, by way of example only, novel user interface elements presented with respect to a web (or other source) page, or executing video previews when a particular representation of a video content item is hovered over. Without limitation, a number of user interface features are described herein below with reference to FIGS. 4-5. It will be understood by those of ordinary skill in the art that a number of other user interface features may be utilized to execute and/or present video previews in accordance with embodiments hereof and that the user interface features shown in FIGS. 4-5 are meant to be merely illustrative of some such features.

With reference to FIG. 4, an illustrative screen display is shown, in accordance with an embodiment of the present invention, of an exemplary user interface 400 showing video representations related to the search result item. More particularly, the user interface 400 shown in FIG. 4 includes a video item representation display area 410. An example of a video item representation is shown at 412. The video item representation 412 includes a video item representation associated with the search result video item that was returned in response to the search query, “Kelly Clarkson”. The video item representations are determined, for instance, by utilizing the video content determining component 220 of FIG. 2. In embodiments, previews of the video content items are presented by presenting a representation of the video preview in association with a video content item but with the video preview appearing as a static video item representation until the user performs a particular action. This user interface feature is particularly useful as it permits the user to preview the video in the search results page without having to first select a video content item.

As previously set forth, detectable user actions may include, without limitation, a hover over at least a portion of a video content item, a scrolling action with respect to the web page in association with which video content items are presented, a scrolling action with respect to a particular presented video representation, a selection of a selectable portion of a video content item, a hover over a video representation associated with one or more presented video content items, or any combination thereof. This is shown in FIG. 4 by icon 414, which represents the location of the user action (e.g., mouse icon). As shown, icon 414 illustrates the user mousing or hovering over video representation 412. In addition to executing the video preview, the user action may also cause control buttons 416 to be presented, allowing the user to control the video preview.

Now referring to FIG. 5, a user interface 500 is shown, in accordance with embodiments of the present invention. The user interface 500 includes a video item representation display area 510 for displaying video item representations, such as video item representation 512 which shows a video representation of a video content item associated with the search query. User interface 500 may, for example, illustrate an interface after the user has selected a video representation as is shown in FIG. 4. In FIG. 5, the selected video content item is played in the video content item display area 514. The search results list (as was shown in FIG. 4) remains in the video item representation display area 510. In 514, the video content item, such as video content item 516, then plays the entire video content item. As in FIG. 4, the video item representations have the capability of dynamically executing or playing a video preview in response to a particular user action.

User interface features, such as those shown in FIGS. 4 and 5, may be implemented using various methods. By way of example, without limitation, the user interface may be implemented with support from a server to provide the relevant video content items. The video previews may be shown by embedding a control in the HTML page that is capable of executing or playing the preview in response to a particular user action. The interaction with these controls may be handled using JavaScript, which would allow the user to play, pause, or otherwise interact with the preview. Dynamic user interface components, such as representations that appear in response to a particular user action, can be handled using JavaScript, which may or may not contact a server to acquire additional information to provide necessary interactivity with the user.

When there are a large number of video content items on a page for which video previews may be desired, it may not be efficient to embed all of the video previews within the page. In this case, once a user performs a particular action that is a pre-condition to exposure and that indicates a video preview is desired for an individual video content item, an asynchronous request may be made to the hosting site for the video preview, which is then displayed dynamically. It will be understood by those of ordinary skill in the art that other implementations may be possible and that embodiments hereof are not intended to be limited to any particular implementation method or process.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media having computer-executable instructions embodied thereon for performing a method for presenting video search results, the method comprising:
receiving a search query;
determining one or more video items relevant to the search query; and
configuring a presentation component to present a representation of each of one or more video items to a user, wherein the representation of each of the one or more video items comprises a video preview that is dynamically executed in response to one or more user actions.

2. The computer-readable media of claim 1, wherein the video preview comprises one or more segments of the video item.

3. The computer-readable media of claim 2, wherein the representation of each of the one or more video items comprises the first scene of the video item associated therewith.

4. The computer-readable media of claim 2, wherein the representation of each of the one or more video items comprises the first segment of the video preview associated therewith.

5. The computer-readable media of claim 1, the presentation component further presents one or more control buttons in response to the one or more user actions.

6. The computer-readable media of claim 1, wherein the one or more user actions includes one of a hover over at least a portion of one of the representations of video items, a scrolling action with respect to the web page, a scrolling action with respect to one of the representations of video items associated with the web page, a selection of one of the representations of video items, a selection of a selectable portion of one of the representations of video items, and a combination thereof.

7. The computer-readable media of claim 1, wherein only one video preview is dynamically executed.

8. A user interface embodied on one or more computer-readable media for presenting video search results in response to an input query, the user interface comprising:
a video item representation display area that displays a representation of each of one or more video items, wherein the one or more video items are relevant to the input query and comprise a video preview, and wherein the video preview is dynamically executed within the video item representation display area in response to one or more user actions; and
a video item display area that displays the one or more video content items.

9. The user interface of claim 8, wherein the video preview comprises one or more segments of the video item.

10. The user interface of claim 8, wherein the representation of each of the one or more video items comprises the first scene of the video item associated therewith.

11. The user interface of claim 9, wherein the representation of each of the one or more video items comprises the first segment of the video preview associated therewith.

12. The user interface of claim 8, the video item presentation display area further comprises one or more control buttons in response to the one or more user actions.

13. The user interface of claim 8, wherein the one or more user actions includes one of a hover over at least a portion of one of the representations of video items, a scrolling action with respect to the web page, a scrolling action with respect to one of the representations of video items associated with the web page, a selection of one of the representations of video items, a selection of a selectable portion of one of the representations of video items, and a combination thereof.

14. The user interface of claim 8, wherein only one video preview is dynamically executed at a time.

15. One or more computer-readable media having computer-executable instructions embodied thereon for performing a method for presenting video search results, the method comprising:
receiving a search query from a user, wherein the search query produces one or more video content items relevant to the search query; and
presenting a representation of each of the one or more video items to a user in a video display area, wherein the representation of each of the one or more video items comprises a video preview that is dynamically executed within the video display area in response to one or more user actions.

16. The computer-readable media of claim 15, wherein the video preview comprises one or more segments of the video item.

17. The computer-readable media of claim 15, wherein the representation of each of the one or more video items comprises the first scene of the video item associated therewith.

18. The computer-readable media of claim 16, wherein the representation of each of the one or more video items comprises the first segment of the video preview associated therewith.

19. The computer-readable media of claim 15, further comprising presenting one or more control buttons in response to the one or more user actions.

20. The computer-readable media of claim 15, wherein the one or more user actions includes one of a hover over at least a portion of one of the representations of video items, a scrolling action with respect to the web page, a scrolling action with respect to one of the representations of video items associated with the web page, a selection of one of the representations of video items, a selection of a selectable portion of one of the representations of video items, and a combination thereof.
